(19) United States
(12) Patent Application Publication
(10) Pub. No.: US 2015/0046437 A1
(43) Pub. Date: Feb. 12, 2015

(54) Search Method

(71) Applicant: Infotext Holdings Pty Ltd, Fortitude Valley (AU)

(72) Inventors: David Connors, Fortitude Valley (AU); Ben Parker, Arana Hills (AU); Joseph Cooney, Newmarket (AU)

(73) Assignee: Infotext Holdings Pty Ltd, Fortitude Valley (AU)

(21) Appl. No.: 14/011,678

(22) Filed: Aug. 27, 2013

(30) Foreign Application Priority Data
Aug. 12, 2013 (AU) 2013214496

(51) Int. Cl. G06F 17/30

(52) U.S. Cl. CPC G06F 17/30554
USPC 707/723

(57) ABSTRACT

The present invention relates to a search method. The method includes the steps of receiving a search query and generating results based upon the received search query. The generated results are classified using classification criteria to form respective result groups. The result groups are displayed, preferably concurrently.

### BENEFIT CLAIM

This application claims the benefit under 35 U.S.C. §119(a) of Australian Patent application 2013214496, filed Aug. 12, 2013, the entire contents of which are hereby incorporated by reference as if fully set forth herein. The applicant(s) hereby rescind any disclaimer of claim scope in the parent application(s) or the prosecution history thereof and advise the USPTO that the claims in this application may be broader than any claim in the parent application(s).

### TECHNICAL FIELD

The present invention generally relates to search engines. The present invention has particular, although not exclusive application to an enterprise search engine for content management and document management web application platforms such as Microsoft™ SharePoint™.

### BACKGROUND

The reference to any prior art in this specification is not, and should not be taken as an acknowledgement or any form of suggestion that the prior art forms part of the common general knowledge.

SharePoint™ is a Web application platform developed by Microsoft. SharePoint™ has historically been associated with content management and document management, but recent versions have significantly broader capabilities.

SharePoint™ can utilise one of a different number of search engines, depending on the edition. These can be used for searching information within an enterprise. An enterprise search can be contrasted with a web search, which applies search technology to documents on the open web, and a desktop search, which applies search technology to the content on a single computer.

SharePoint™ search results are typically displayed as a list of results. The results list typically includes a document title, a brief synopsis and a uniform resource locator (URL) from which to obtain the document. The results list is typically often long, spreading over many pages thereby making it difficult to locate relevant results. Furthermore, many of the results in the list are of little relevance to the searcher also making it difficult to locate relevant results.

Embodiments of the present invention provide a search engine to facilitate improved location of relevant results.

### SUMMARY OF THE INVENTION

According to one aspect of the present invention, there is provided a search method including the steps of:
receiving a search query;
generating results based upon the received search query;
classifying the generated results using classification criteria to form respective result groups; and
displaying the result groups.

Advantageously, the displayed result groups may provide a more compact and dense presentation of results compared with the known enterprise search engines above to improve the location of relevant results. The preferred embodiment also provides filtering, sorting and removing of results to further improve the location of relevant results.

Optionally, the search query is input, and then processed and altered to form an altered search query, prior to being received by a conventional (e.g. SharePoint™) search engine. The conventional search engine may generate the results. The method may further include the step of receiving selection of a result in a group. The method may further include the step of performing an action based upon the selection. The action may include opening a document.

The method may include incremental real-time searching as the the search query is received which was not previously possible using SharePoint™.

The method may further include displaying result subgroups within a group formed by classifying the results in the group in accordance with subgroup criterion. The subgroup criterion may include document type.

The method may include removing undesirable results before displaying. The step of removing may include filtering out undesirable results based upon one or more filtering criteria. The filtering criteria may include the type of a result. The method may include extracting meaningful details from the results and for displaying. The method may further include the step of filtering out results prior to displaying. The filtered out results may include results created by a machine (e.g. automated system accounts and services) rather than a human.

The step of classifying may use machine learning techniques (e.g. involving determining a Levenshtein distance between document properties). The classification criteria may use properties from another search engine or the source document such as author or title properties.

Typically, the step of generating results involves storing the results in a data structure for classifying.

Preferably, the result groups are concurrently displayed. The result groups may include common results. Each result may be any one of a result indicator, a hyperlink, a database record, a document link and a document. Each group may include results displayed as a list. The method may involve sorting the results within a group by selecting a field. The method may include the step of expanding a group to see a greater number of results in the group.

Preferably, the step of receiving involves parsing a search string into components. The method further involves the step of performing an operation when identifying a component as an operator. The method may further include the step of automatically applying at least one search wildcard to the string.

According to another aspect of the present invention, there is provided a search method including the steps of:
classifying generated search results using classification criteria to form respective result groups; and
displaying the result groups.

According to another aspect of the present invention, there is provided a search engine including:
a processor for generating results based upon a search query, and classifying the generated results using classification criteria to form respective result groups for display on a display.

Preferably, the search engine includes a user interface for receiving the search query.

Each group may include selectable results. The search engine may include a selector for selecting the results. The selector may include a mouse or touch screen.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a block diagram of an enterprise's networked computer system including a search engine in accordance with an embodiment of the present invention;

FIG. 2 is a flowchart of a search method performed by the search engine of FIG. 1; and

FIG. 3 is a schematic diagram of example search results generated during the search method of FIG. 2.

### DETAILED DESCRIPTION OF PREFERRED EMBODIMENTS

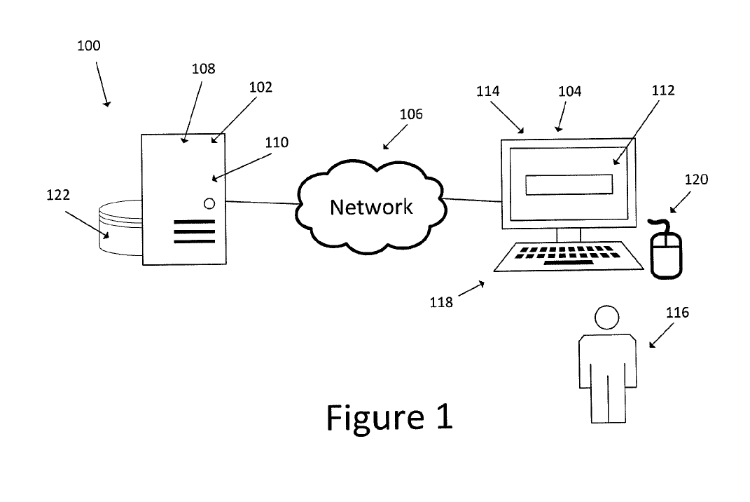

An enterprise's networked computer system 100 is shown in FIG. 1. The computer system 100 includes a computer server 102 loaded with the document management web application platform such as Microsoft™ SharePoint™ which can be accessed by user computer 104 over a network 106.

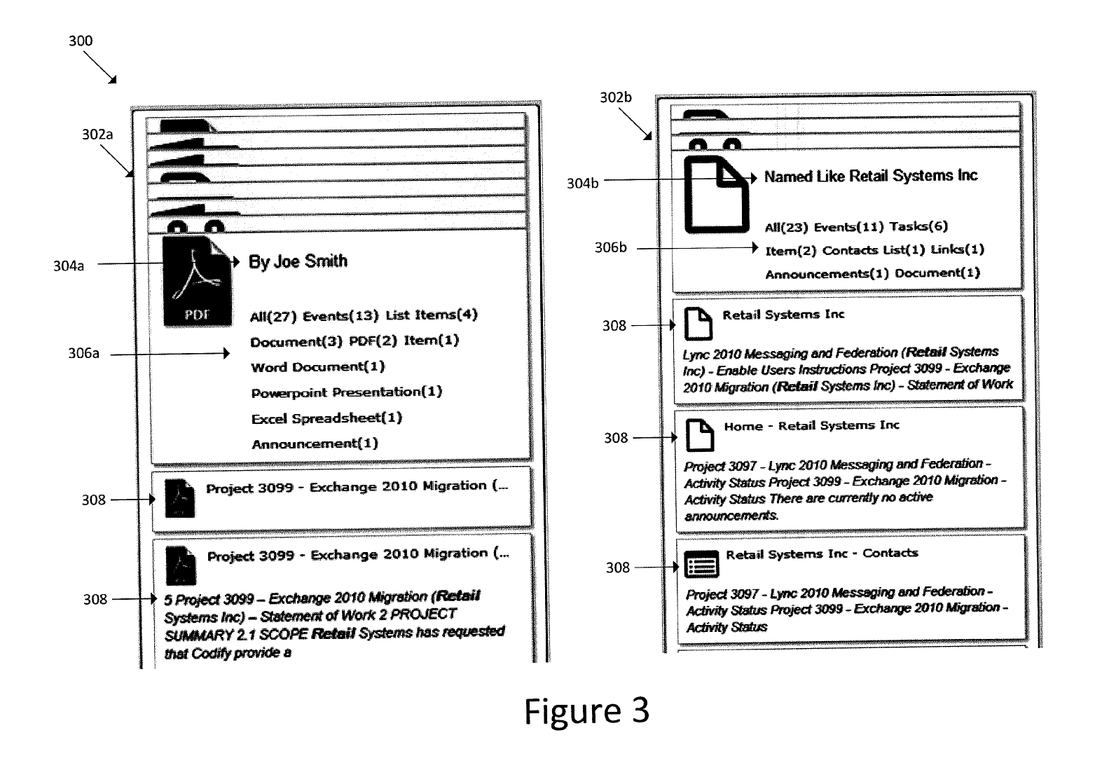

According to an embodiment of the present invention, the computer server 102 is loaded with Application software that configures the computer server 102 as an enterprise search engine 108 for Microsoft™ SharePoint™. The search engine 108 includes a processor 110 for generating results based upon a search query received in an input field 112. The processor 110 further classifies the generated results, using classification criteria, to form respective result groups. The search engine 108 generates the results and transmits them over the network for display on the searchers computer 104 and displays the result groups 302a, 302b (see FIG. 3).

Advantageously, the displayed result groups provide a far more compact and dense presentation of results compared with known enterprise search engines to improve the location of relevant results by a searcher 116. The search engine 108 also provides filtering, sorting and removing of results to further improve the location of relevant results as described in detail below.

The searcher's computer 104 includes a user interface in the form of a keyboard 118 for receiving the search query in the form of a search string entered into an entry field 112. The user interface may be transferred from the server 102 to the searcher's computer 104. A selector in the form of a mouse 120 is provided for selecting the search results. The computer server 102 accesses an enterprise database 122 which includes the enterprise records that the search engine 108 searches and from which the results are obtained.

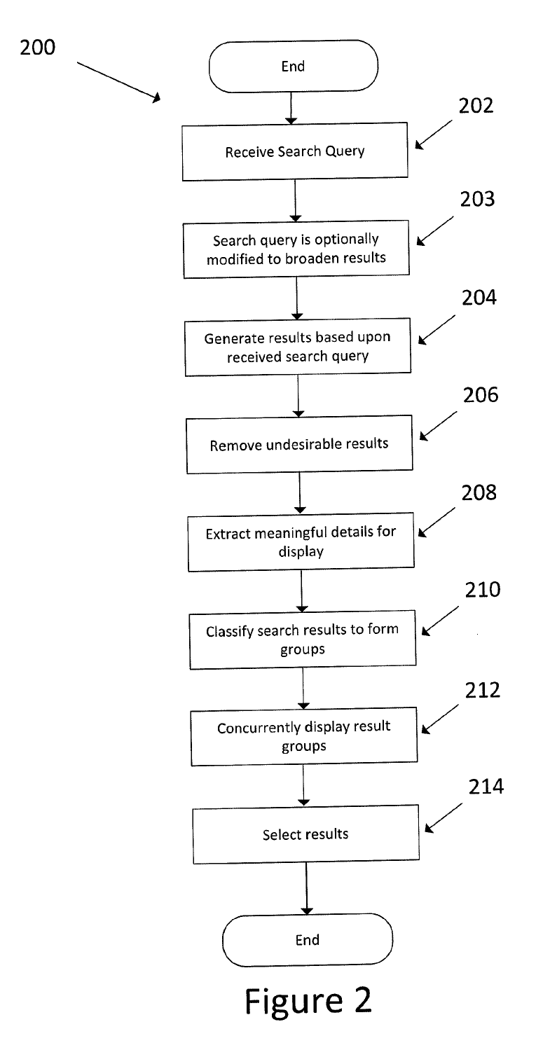

A search method 200 performed by the search engine 108 is described below with reference to FIG. 2.

At step 202, the search engine 108 receives a search query in the form of a search string in input field 112. The search string is parsed into components including operators (e.g. Boolean operator “AND”, “−” exclusion operator to omit search results including a particular term, and quotes for exact search) and search terms (e.g. “retail”). An operation is performed on the text when identifying another component as an operator. In this manner, the search query can be processed and altered to form an altered search query.

At step 203, search wildcard (*) is automatically applied to the end of each search term within the string as it is received to broaden the search, unless otherwise restricted by the searcher 116. In this manner, incremental real-time searching is performed as the search query is received.

At step 204, the search engine 108 generates results based upon the received search query (e.g. retail). The generated results are stored in a data structure for further processing and classifying. The generated results may be generated in accordance with known search techniques or an existing SharePoint™ search interface.

At step 206, the search engine 108 removes spurious or undesirable results from the generated results. Elaborating further, undesirable results are filtered out from the data structure based upon one or more filtering criteria such as the type of a result.

Search results which match with some criterion (e.g. name) but are of different (undesirable) types are stripped out. For example, if the underlying search indexing includes a navigation option that includes likely search terms, then this can cause index and home pages to all match results that include those search terms. The searcher 116 rarely requires all index and home pages, and so these pages are excluded based on the type of the page retrieved from system meta data. In the present SharePoint embodiment, results of type STS_List_DocumentLibrary and STS_List_WebPageLibrary are removed. These types of results are SharePoint specific and other meta data could also be removed. These types can be configured in the system.

Similarly, results which were created by a machine (e.g. automated system accounts and services) rather than a human are filtered out.

At step 208, the search engine 108 extracts meaningful details from the results to display to the human searcher 116. Elaborating further, underlying search indexing used to generate the search results can also produce undesirable and repetitive results. For example, SharePoint includes individual list items being returned with a title such as “dispform.aspx”. Where certain classes of results have repetitive or meaningless titles, other properties from the document are extracted and instead form the displayed search result titles.

At step 210, the search engine 108 classifies the remaining generated results using classification criteria to form respective results groups or clusters. The classification criteria includes a document author property (e.g. authored by “Joe Smith”) or a title property (e.g. “retail” in title). The classification criteria are applied to the same stored results to produce respective result groups.

The step of classifying involves employing automated machine learning to identify those results which are meaningful to searchers 116 by virtue of being learned from searchers 116 selection of results. Classifications are not manually curated or maintained by a human. Instead, for example, a figure can be calculated from a Levenshtein distance between document properties, normalised for string length, and is used as the basis for classification.

Other determinations are made during classification and grouping based on rules such as whether or not the searcher 116 is a system account or a human. Whilst humans have interest in viewing the classified and grouped results, classification and grouping procedures need not be performed in the event that the searcher 116 is not a human.

The classification process at step 210 creates groups on the basis of the machine learning techniques and not on the basis of search terms entered by the user. For example, if a search was performed for “retail” and a number of results were returned with titles similar to “Sales forecast”, then the classification process would produce a group based on the learned similarity of “Sales forecast” and the group would be shown as “Sales forecast” even though the search term was “retail”.

At step 212, the search engine 108 displays screen 300, in turn, concurrently displaying the two result groups 302a, 302b as shown for example in FIG. 3 (for a search query “retail”). The first result group 302a has an author results type 304a whereby all results relate to a particular author (e.g. Joe Smith). The second result group 302b has a title results type 304b whereby the search term “retail” has been entered. The classifier process at step 210 examines the total set of results returned from the search engine and that match the search term (e.g. “retail”). The classifier process at step 210 determines that a group is to be created for all search results with a similar title (e.g. “Retail Systems Inc”). The classifier process at step 210 can use a Levenshtein distance normalised for string length or other machine learning technique. Advantageously, the classified group may or may not contain the original search term as the search and classification processes are separate.

Each result group 302a, 302b includes result sub-classifications 306a, 306b. Each group 302 includes results 308 displayed as a list and indicating the fields (e.g. title, document type, etc.). The results 308 within a group 302 are by default sorted according to relevance, although can be sorted by selecting with the mouse 120 a particular field 306. Multiple groups 302 can be presented in a window, and can include many more results that can be displayed. Each window can be scrolled, maximized (i.e. expanded to view more results) or minimized using the mouse 120 to alter the results 308 displayed.

The result groups 302 can include common results (e.g. document entitled “retail therapy” authored by J Smith). Each result 308 is selectable with the mouse 120 to launch an appropriate program (e.g. Microsoft Word) and load a corresponding document (e.g. parts list.docx).

At step 214, the search engine 108 receives a selection of a result (e.g. parts list.docx) in a group 302a from the searcher 116 using the mouse. An appropriate program (e.g. Microsoft Word) is launched and the document is opened.

A person skilled in the art will appreciate that many embodiments and variations can be made without departing from the ambit of the present invention.

In one embodiment, the user interface 118 and selector 120 are combined in the form of a touch screen.

Each result 308 can be any one of a result indicator, a hyperlink, a database record, a document link, and a document.

Steps 202 and 204 above can be performed by a generic SharePoint™ search engine, with the other steps (including step 203) being performed by custom application software. Alternatively, an integrated purpose built search engine may implement all of the steps of method 200.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

What is claimed is:

1. A search method including the steps of:
receiving a search query;
generating results based upon the received search query;
classifying the generated results using classification criteria to form respective result groups; and
displaying the result groups.

2. A search method as claimed in claim 1, further including any one or more of filtering, sorting and removing results to improve the location of relevant results.

3. A search method as claimed in claim 1, further including the step of receiving selection of a result in a group.

4. A search method as claimed in claim 3, further including the step of performing an action based upon the selection.

5. A search method as claimed in claim 4, wherein the action includes opening a search result in the form of a document.

6. A search method as claimed in claim 1, further involving displaying result subgroups, within a group, formed by classifying the results in the group in accordance with subgroup criterion.

7. A search method as claimed in claim 6, wherein the subgroup criterion includes result type.

8. A search method as claimed in claim 1, further including removing undesirable results before displaying.

9. A search method as claimed in claim 8, wherein the removing includes filtering out undesirable results based upon one or more filtering criteria.

10. A search method as claimed in claim 9, wherein the filtering criteria includes the type of a result.

11. A search method as claimed in claim 1, including extracting meaningful details from the results and for displaying.

12. A search method as claimed in claim 1, further including the step of filtering out results prior to displaying.

13. A search method as claimed in claim 12, wherein the filtered out results include results created by a machine rather than a human.

14. A search method as claimed in claim 1, wherein the step of classifying involves determining a distance between document properties.

15. A search method as claimed in claim 1, wherein the classification criteria includes a search engine result or document property related to author or title.

16. A search method as claimed in claim 1, wherein the step of generating involves storing results in a data structure for classifying.

17. A search method as claimed in claim 1, wherein the result groups are concurrently displayed and can include common results.

18. A search method as claimed in claim 1, wherein the step of receiving the search query involves:
applying at least one search wildcard to the string for incremental real-time searching as the search query is received; and/or
altering an input search query to form the received search query.

19. A search method including the steps of:
classifying generated search results using classification criteria to form respective result groups; and
displaying the result groups.

20. A search engine including:
a processor for generating results based upon a search query, and classifying the generated results using classification criteria to form respective result groups for display on a display.
